(19) United States
(12) Patent Application Publication
(10) Pub. No.: US 2015/0112975 A1
(43) Pub. Date: Apr. 23, 2015

(54) CONTEXT-AWARE SEARCH APPARATUS AND METHOD

(71) Applicant: SAMSUNG ELECTRONICS CO., LTD., Suwon-si (KR)

(72) Inventor: Eun-Hee RHIM, Yongin-si (KR)

(73) Assignee: SAMSUNG ELECTRONICS CO., LTD., Suwon-si (KR)

(21) Appl. No.: 14/299,133

(22) Filed: Jun. 9, 2014

(30) Foreign Application Priority Data
Oct. 21, 2013 (KR) 10-2013-0125450

(51) Int. Cl. G06F 17/30

(52) U.S. Cl. CPC G06F 17/30867; G06F 17/30598
USPC 707/723; 707/769; 707/740

(57) ABSTRACT

A context-aware search apparatus and method are disclosed. The context-aware search apparatus includes a storage configured to store information about personal raw data collected from a routine activity of a user and life log information of the user, a communicator configured to communicate with a user equipment apparatus, and a controller configured to, in response to receiving a search request of the user through the communicator, extract a keyword from the search request, search the storage for information associated with the keyword based on the life log information of the user, and transmit a result of the search to the user equipment apparatus. Thus, the context-aware search apparatus provides a search result appropriate for a user based on personal raw data collected from a routine activity of the user.

### CROSS-REFERENCE TO RELATED APPLICATION(S)

This application claims priority from Korean Patent Application No. 10-2013-0125450, filed on Oct. 21, 2013, in the Korean Intellectual Property Office, the disclosure of which is incorporated herein by reference in its entirety.

### BACKGROUND

1. Field

Apparatuses and methods consistent with exemplary embodiments relate to a context-aware search apparatus and method, and more particularly, to a context-aware search apparatus and method, which collects and analyzes life log information of a user and provides a search result appropriate for the user.

2. Description of the Related Art

In general, searching service technologies for providing a search result according to a search request of a user provide a search result according to a search request of a user based on general experience data. That is, search service technologies of the related art generate experience data for providing a search result to a user via cumulative statistics about a search result according to a search request of a plurality of users.

For example, with regard to a specific broadcast program, search service technologies of the related art provide only a search result about the time and date when the corresponding broadcast program begins, or characters, etc. of the broadcast program.

Thus, even if users have different interests with regard to the corresponding broadcast program, only general search results are provided to users instead of search results appropriate for each of the respective users.

### SUMMARY

Exemplary embodiments address at least the above problems and/or disadvantages and other disadvantages not described above. Also, exemplary embodiments are not required to overcome the disadvantages described above, and an exemplary embodiment may not overcome any of the problems described above.

One or more exemplary embodiments provide a context-aware search apparatus and method, which provides a search result appropriate for a user based on personal raw data collected from a routine activity of the user.

One or more exemplary embodiments may also provide a context-aware search apparatus and method, which collects and analyzes life log information to a user and provides a search result appropriate for the user.

According to an aspect of an exemplary embodiment, there is provided a context-aware search apparatus including: a storage configured to store information about personal raw data collected from a routine activity of a user and life log information of the user; a communicator configured to communicate with a user equipment apparatus; and a controller configured to, in response to receiving a search request of the user through the communicator, extract a keyword from the search request, search the storage for information associated with the keyword based on the life log information of the user, and transmit a result of the search to the user equipment apparatus.

The controller may be further configured to, in response to the personal raw data being collected, classify the personal raw data into a plurality of experience information units based on correlations in the personal raw data, store the plurality of experience information units in the storage, group the plurality of experience information units in units of episodes, and store, in the storage, the plurality of experience information units as a plurality of episode information units.

The controller may be further configured to, in response to the keyword being extracted from the search request, select at least one extension keyword based on the life log information of the user and search for information associated with the keyword and the extension keyword from among the plurality of experience information units and the plurality of episode information units.

The controller may be further configured to apply priority to a plurality of items included in the result of the search based on a search history of the user, align the plurality of items according to the applied priority, and provide the aligned plurality of items to the user equipment apparatus.

The personal raw data may include at least one from among a still image, a moving picture, a phone log, social network service (SNS) history information, and short message service (SMS) information.

The life log information of the user may include at least one from among personal information of the user, family information of the user, interest information of the user, search history information of the user, and activity pattern information of the user.

Each of the plurality of experience information units may include at least one from among identification information for identifying the personal raw data, context information, uniform resource locator (URL) information about a source providing the personal raw data, and counting information about a number of times the personal raw data is accessed.

According to an aspect of another exemplary embodiment, there is provided a context-aware search method including: storing information about personal raw data collected from a routine activity of a user and life log information of the user; receiving a search request of the user from a user equipment apparatus, extracting a keyword from the search request and searching for information associated with the keyword based on the life log information of the user; and transmitting a result of the search to the user equipment apparatus.

The storing may include: classifying the personal raw data into a plurality of experience information units based on correlations in the personal raw data and storing the plurality of experience information units; and grouping the plurality of experience information units in units of episodes and storing the plurality of experience information units as a plurality of episode information units.

The searching may include: selecting at least one extension keyword based on the life log information of the user in response to the keyword being extracted from the search request; and searching for information associated with the keyword and the extension keyword among the plurality of experience information units and the plurality of episode information units.

The transmitting may include: applying priority to a plurality of items included in the result of the searching based on a search history of the user; aligning the plurality of items according to the priority; and transmitting a result of the searching including an item corresponding to a preset sequence among the plurality of aligned items, to the user equipment apparatus.

The personal raw data may include at least one from among a still image, a moving picture, a phone log, social network service (SNS) history information, and short message service (SMS) information.

The life log information of the user may include at least one from among personal information of the user, family information of the user, interest information of the user, search history information of the user, and activity pattern information of the user.

Each of the plurality of experience information units may include at least one from among identification information for identifying the personal raw data, context information, uniform resource locator (URL) information about a source providing the personal raw data, and counting information about a number of times the personal raw data is accessed.

According to an aspect of another exemplary embodiment, there is provided a context-aware search method including: collecting personal raw data corresponding to an activity of a user; transmitting the personal raw data to a context-aware search apparatus; transmitting a search request to the content-aware search apparatus; and receiving, in response to the transmitting the search request, a result of the search, wherein the result of the search is generated by searching for information corresponding the personal raw data based on a keyword extracted from the search request and an extension keyword based life log information of the user.

The personal raw data may be classified into a plurality of experience information units based on correlations in the personal raw data.

The plurality of experience information units may be grouped into a plurality of episode information units.

The searching for information may include searching for information associated with the keyword and the extension keyword from among the plurality of experience information units and the plurality of episode information units

The personal raw data may include at least one from among a still image, a moving picture, a phone log, social network service (SNS) history information, and short message service (SMS) information.

The life log information of the user may include at least one from among personal information of the user, family information of the user, interest information of the user, search history information of the user, and activity pattern information of the user.

The method may further include displaying the result of the search.

The result of the search may include a plurality of items, and the method may further include sequentially displaying the plurality of items based on a priority of each of the plurality of items.

According the aforementioned exemplary embodiments, a context-aware search apparatus provide a search result appropriate for a user based on personal raw data collected from a routine activity of the user and collect and analyze life log information to a user and provide a search result appropriate for the user.

Additional and/or other aspects and advantages of the exemplary embodiments will be set forth in part in the description which follows and, in part, will be obvious from the description, or may be learned by practice of the exemplary embodiments.

### BRIEF DESCRIPTION OF THE DRAWINGS

The above and/or other aspects will become more apparent by describing certain exemplary embodiments with reference to the accompanying drawings, in which:

FIG. 1 is a diagram illustrating a context-aware search system according to an exemplary embodiment;

FIG. 2 is a block diagram of a context-aware search apparatus according to an exemplary embodiment;

FIG. 3 is a diagram of exemplary software configuration and software execution of a context-aware search apparatus according to an exemplary embodiment;

FIG. 4 is a diagram of an exemplary case in which a user equipment apparatus provides a search result according to a search request of a user, according to an exemplary embodiment;

FIG. 5 is a flowchart of a context-aware search method for providing a search result according to a search request of a user by a context-aware search apparatus according to an exemplary embodiment;

FIG. 6 is a flowchart of a method of generating and storing information about personal raw data by a context-aware apparatus according to an exemplary embodiment;

FIG. 7 is a flowchart of a search method according to a search request of a user by a context-aware search apparatus according to an exemplary embodiment; and

FIG. 8 is a flowchart of a method of transmitting a retrieved search result associated with a search request of a user by a context-aware search apparatus to a user equipment apparatus according to an exemplary embodiment.

### DETAILED DESCRIPTION OF EXEMPLARY EMBODIMENTS

Certain exemplary embodiments will now be described in greater detail with reference to the accompanying drawings.

In the following description, the same drawing reference numerals are used for the same elements, even in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, well-known functions or constructions are not described in detail since they would obscure the exemplary embodiments with unnecessary detail.

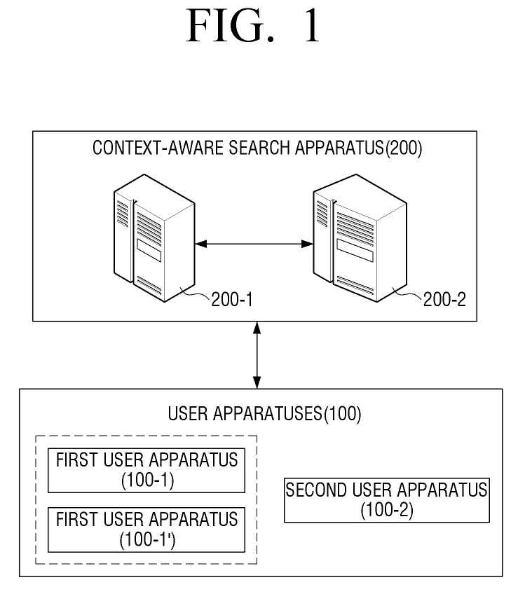

FIG. 1 is a diagram illustrating a context-aware search system according to an exemplary embodiment.

As illustrated in FIG. 1, the context-aware search system includes a plurality of user equipment apparatuses 100 and a context-aware search apparatus 200.

The user equipment apparatus 100 may be a terminal, such as a smart phone, a smart television (TV), a tablet personal computer (PC), etc., which communicates though wired or wireless communication. The user equipment apparatus 100 records and stores personal raw data according to routine activities of a user. The user equipment apparatus 100 may transmit a request to a pre-registered context-aware search apparatus of the context-aware search apparatus 200 to upload the pre-stored personal raw data according to an upload request of the user.

Here, the personal raw data may be at least one of a still image or moving picture captured by the user, note information such as a schedule or a memo, a phone log, social network service (SNS) history information, and short message service (SMS) information.

According to the upload request for the personal raw data, the context-aware search apparatus 200 may store the personal raw data received from the user equipment apparatus 100.

Upon communicating with the user equipment apparatus 100 and receiving the personal raw data pre-stored in the user equipment apparatus 100, the context-aware search apparatus 200 may store information about the personal raw data. However, exemplary embodiments are not limited thereto. The context-aware search apparatus 200 may periodically receive the pre-stored personal raw data from the user equipment apparatus 100 and may store the information about the received personal raw data.

As illustrated in FIG. 1, a first context-aware search apparatus 200-1 may communicate with pre-registered first and second user equipment apparatuses 100-1 and 100-2 to receive personal raw data pre-stored in the first and second user equipment apparatuses 100-1 and 100-2, respectively, and to store information about the received personal raw data.

Upon receiving a search request of a user from the first user equipment apparatus 100-1, the first context-aware search apparatus 200-1 extracts a keyword from the received search request. Upon extracting the keyword, the first context-aware search apparatus 200-1 searches for information associated with the extracted keyword from among a plurality of the information about the pre-stored personal raw data based on life log information of the corresponding user and transmits a search result according to the search to the first user equipment apparatus 100-1.

Here, the life log information may include at least one of personal information about a user name and a user phone number, family information, interest information, search history information, activity pattern information, and the like.

Thus, the first context-aware search apparatus 200-1 may search for the information associated with the extracted keyword from among the plurality information about the pre-stored personal raw data based on the life log information and transmit the search result according to the search to the user equipment apparatus 100-1.

A user of the first user equipment apparatus 100-1 may use a sub-user equipment apparatus 100-1′. The second context-aware search apparatus 200-2 may store information about personal raw data collected from the sub-user equipment apparatus 100-1′.

Accordingly, upon receiving a search request of the user from the first user equipment apparatus 100-1, the first context-aware search apparatus 200-1 may search for information associated with the pre-extracted keyword among a plurality of information about the personal raw data associated with the corresponding user, pre-stored in the first and second context-aware search apparatus 200-1 and 200-2, based on the life log information of the corresponding user and transmit a search result according to the search to the first user equipment apparatus 100-1.

Thus, the first user equipment apparatus 100-1 may provide a search result list according to the search result received from the first context-aware search apparatus 200-1 such that that user may easily search for personal data as a target among a numerous amount of personal data distributed and stored in a plurality of context-aware search apparatuses 200.

Thus far, the context-aware search system according to an exemplary embodiment has been described in briefly. Hereinafter, the context-aware search apparatus 200 will be described in more detail.

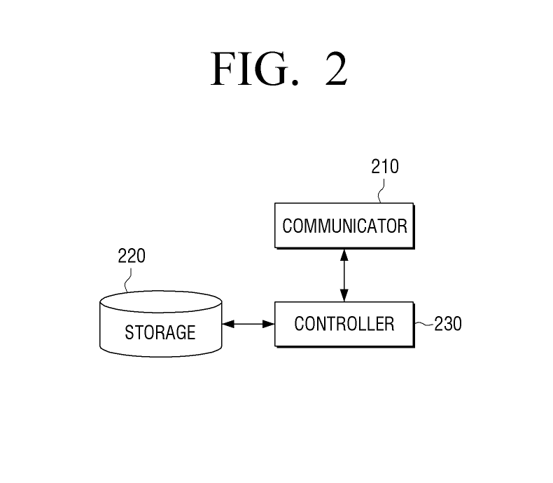

FIG. 2 is a block diagram of a context-aware search apparatus 200 according to an exemplary embodiment.

As illustrated in FIG. 2, the context-aware search apparatus 200 includes a communicator 210, a storage 220, and a controller 230. The communicator 210 communicates with the user equipment apparatus 100. The communicator 210 may communicate with the user equipment apparatus 100 via various communication protocols such as a hypertext transfer protocol (HTTP), an extensible messaging and presence protocol (XMPP), a secure sockets layer (SSL), a file transfer protocol (FTP), content centric networking (CCN), etc. However, exemplary embodiments are not limited thereto. The communicator 210 may wirelessly communicate with the user equipment apparatus 100 via various wireless communication standards such as WiFi, 3^{rd} generation (3G), 3^{rd} generation partnership project (3GPP), long term evolution (LTE), etc.

The storage 220 stores information about personal raw data collected from routine activities of a user and life log information of the corresponding user. In addition, upon receiving a search request of the user from the user equipment apparatus 100 via the communicator 210, the controller 230 extracts a keyword from the received search request. Then, the controller 230 searches the storage 220 for information associated with the keyword based on pre-defined life log information of the corresponding user and controls the communicator 210 to transmit a search result according to the search to the communicator 210.

The aforementioned personal raw data includes at least one of a still image or moving picture captured by the user, note information input by the user in relation to a schedule or a memo, a phone log, history information using an SNS application, and SMS information. However, exemplary embodiments are not limited thereto. The personal raw data may include any information collected according to routine activities of the user via the user equipment apparatus 100 or content usage information according to content usage, provided from an external server (not shown).

The personal raw data may be pre-stored in the user equipment apparatus 100 or registered and stored in the storage 220 according to an upload request of the user. However, exemplary embodiments are not limited thereto. The personal raw data may be periodically received from the user equipment apparatus 100 and registered and stored in the storage 220 without a separate upload request. The personal raw data of the user may be stored in the sub-user equipment apparatus 100-1′ as well as in the user equipment apparatus 100 of the corresponding user. That is, when the personal raw data is collected from routine activities, the sub-user equipment apparatus 100-1′ may pre-store the collected personal raw data or register and store the personal raw data in the storage 220 or another context-aware search apparatus periodically or in response to an upload request of the user.

Thus, the controller 230 collects the personal raw data registered and stored in the storage 220, the personal raw data pre-stored in the user equipment apparatus 100, and the personal raw data pre-stored in another context-aware search apparatus, classifies the personal raw data into a plurality of experience information units based on correlations between all the collected personal raw data, and stores the plurality of experience information units in the storage 220. In addition, the controller 230 groups the plurality of experience information units in units of episodes and stores a plurality of episode information units in the storage 220.

Here, an experience information unit may include at least one of identification information for identifying the personal raw data, context information, URL information about a source providing the corresponding personal raw data, and counting information about a number of times the corresponding personal raw data is accessed.

For example, in the case of personal raw data about a picture captured from routine activities of the user, the controller 230 may generate a second experience information unit including context information about at least one of identification information of the picture, a date, time, and location in which the picture was captured, and a title of the picture, URL information in which the picture is registered and stored, and counting information based on a number of times the picture is accessed.

As another example, in the case of personal raw data about a note written based on routine activities of the user, the controller 230 may generate a second experience information unit including context information about identification information of a note, a date and time when the note was generated, and text information written on the note, URL information in which the note is registered and stored, and counting information based on a number of times the corresponding picture is accessed.

When a plurality of experience information units are generated based on the personal raw data, the controller 230 may group associated experience information units among the plurality of pre-generated experience information units to generate episode information units and store the episode information units in the storage 220. Here, an episode information unit may include at least one of identification information for identifying the corresponding episode information unit, information about a source providing personal raw data for respective experience information units included in the corresponding episode information unit, context information, and counting information about a number of times the episode information unit is accessed.

As described above, when the first experience information unit and the second experience information unit are generated based on the personal raw data of the picture and the personal raw data of the note, respectively, the controller 230 may group the first and second experience information units in units of episodes based on context information included in the first and second experience information units to generate a first episode information unit.

In detail, the controller 230 determines the first and second experience information units as associated information with reference to a date on which the picture and the note are registered, a picture title, text information recorded in the note, etc., included in the context information of the first and second experience information units. Thus, the controller 230 may group the first and second experience information units in units of episodes to generate episode information units. That is, the controller 230 may group the first and second experience information units to generate the episode information unit including identification information about the generated episode information unit, identification information for identifying the first and second experience information units, context information included in the first and second experience information units, and counting information based on a number of times the corresponding episode information unit is accessed. In this case, when the episode information unit is initially generated, the corresponding episode information unit may unit not contain the counting information. In addition, the identification information about the episode information unit may be set in an order in which the episode information unit is generated or set based on naming information received according to a user request. Alternatively, the identification information about the episode information unit may be set based on context information included in the corresponding episode information unit.

Upon receiving the search request of the user from the user equipment apparatus 100, the controller 230 extracts a keyword from the received search request. Here, the search request of the user may be information generated based on a voice generated from the user or an input command according to manipulation of a keypad (not shown) of the user equipment apparatus 100 by the user. Thus, upon receiving the search request, the controller 230 extracts a keyword from the received search request and selects at least one extension keyword about the extracted keyword based on life log information of the user. Then, the controller 230 may search for information associated with the extracted keyword and extension keyword selected in relation to the corresponding keyword among a plurality of experience information units and a plurality of episode information units, which are pre-stored in the storage 220 and transmit a search result to the corresponding user equipment apparatus 100.

Here, the life log information may include at least one of personal information of the user, family information of the user, interest information of the user, a search history of the user, and activity pattern information of the user.

For example, upon receiving a search request “family trip last summer”, the controller 230 extracts keywords “last year”, “summer”, “family”, and “trip”. Upon extracting the keywords, the controller 230 may select extension keywords from at least one of the pre-extracted keywords based on pre-defined life log information. For example, the controller 230 may select extension keywords “users”, “spouses”, “sons and daughters”, “parents”, “brothers and sisters”, and “grand-parents” from the keyword “family”.

When the extension keywords of the keyword are selected, the controller 230 may search for information associated with at least one of the pre-extracted and pre-selected extension keywords, with reference to context information included in a plurality of episode information units and a plurality of experience information units pre-stored in the storage 220, and transmit a search result according to the search to the user equipment apparatus 100. That is, the controller 230 may search for episode information units and experience information units generated based on the most recently collected personal raw data from personal raw data collected according to a routine activity of the user and transmit a search result according to the search to the user equipment apparatus 100.

The controller 230 applies priority to a plurality of items included in the search result based on a search history of the user. Then, the controller 230 may align a plurality of items according to the applied priority and transmit the plurality of items to the user equipment apparatus 100.

As in the aforementioned example, a keyword may be extracted from a search request “family trip last summer”, an extension keyword may be selected in relation to the extracted keyword, and a search result of items may be induced in relation to the keyword and the extension keyword. In this case, the controller 230 applies priority to each of the items in an order from an item that is most searched for by the user based on counting information included in episode information units or experience information units associated with the retrieved items. Then, the controller 230 may align the items according to priority and transmit the items to the user equipment apparatus 100.

The controller 230 may induce a search result of items, the number of which exceeds a preset number of items in relation to the keyword and the extension keyword. In this case, the controller 230 may select only a certain number of items among the retrieved items and transmit the certain number of items to the user equipment apparatus 100.

According to an exemplary embodiment, when a search result of items is induced, the controller 230 applies priority to each of the items in an order from an item that is most searched for by the user based on counting information included in episode information units or experience information units associated with each of the items. Then, the controller 230 may align the items according to priority, select only the items within preset sequences among the aligned items, and transmit the selected items to the user equipment apparatus 100.

According to another exemplary embodiment, when a search result of items is induced, the controller 230 may align the items in an order from an item having highest correlation with a keyword and an extension keyword with reference to context information included in episode information units or experience information units associated with each of the items, select only a preset number of items from the items having a high correlation, and transmit the preset number of items to the user equipment apparatus 100.

According to another exemplary embodiment, when a search result of items is induced, the controller 230 may select only a specific item based on context information included in episode information units or experience information units associated with each of the items and most-recently set life log information and transmit the specific item to the user equipment apparatus 100. As in the aforementioned example, extension keywords “users”, “spouses”, “sons and daughters”, “parents”, “brothers and sisters”, and “grand-parents” may be selected from the keyword “family” and the extension keywords “spouses” and “sons and daughters” among the extension keywords may be the most recently set life log information in relation to the keyword “family”.

Thus, when a search result of items is induced, the controller 230 may select only an item associated with at least one extension keyword of “spouses” and “sons and daughters” with reference to context information included in episode information units and experience information units associated with each of the items and transmit the selected item to the user equipment apparatus 100.

The controller 230 selectively performs various control operations according to execution of various software pre-stored in the storage 220. According to the control operations, an operation of the context-aware search apparatus 200 may be performed according to execution of various software.

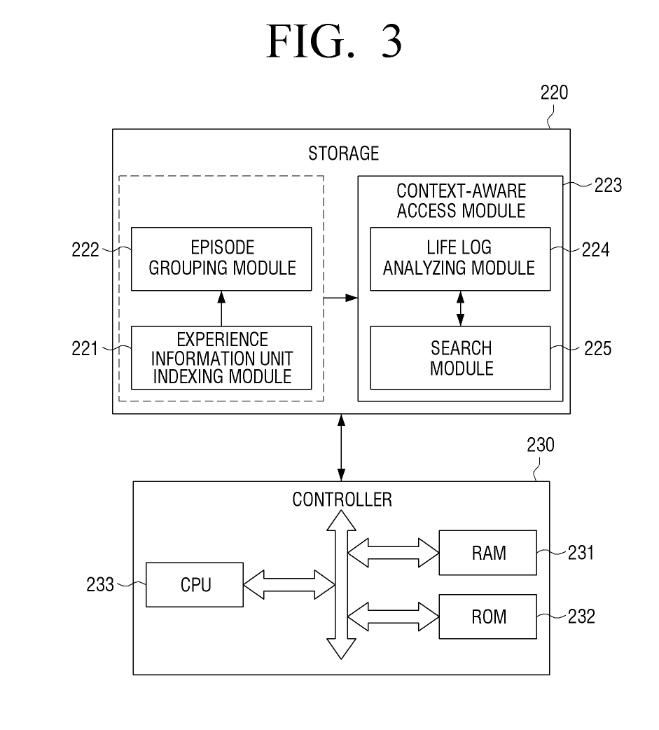

FIG. 3 is a diagram of exemplary software configuration and software execution of a context-aware search apparatus 200 according to an exemplary embodiment.

As illustrated in FIG. 3, software may be stored in the storage 220. However, exemplary embodiments are not limited thereto. The software may be stored in various types of storages used in the context-aware search apparatus 200.

In detail, the storage 220 includes various software modules for controlling an operation of the context-aware search apparatus 200. As illustrated in FIG. 3, the storage 220 includes an experience information unit indexing module 221, an episode grouping module 222, and a context-aware access module 223.

The experience information unit indexing module 221 generates and stores experience information units about personal raw data collected from a routine activity of a user. An experience information unit may include at least one of identification information for identifying the personal raw data, context information, URL information about a source providing the corresponding personal raw data, and counting information about a number of times the corresponding personal raw data is accessed.

The episode grouping module 222 groups associated experience information units among experience information units about personal raw data generated from the experience information unit indexing module 221 and generates and stores the grouped experience information units. Here, the episode information unit may include at least one of identification information for identifying the corresponding episode information unit, information about a source providing personal raw data for respective experience information units included in the corresponding episode information unit, context information, and counting information about a number of times the episode information unit is accessed.

The context-aware access module 223 is a module that searches for information associated with a search request of the user from among information generated from the experience information unit indexing module 221 and the episode grouping module 222 and induces a search result according to the search. The context-aware access module 223 may include a life log analyzing module 224 and a search module 225.

The life log analyzing module 224 is a module that analyzes a search request of the user to extract a keyword and selects at least one extension keyword in relation to the pre-extracted keyword based on the pre-defined life log information of the corresponding user. Here, the life log information may include at least one of personal information about a user, family information of the user, interest information of the user, search history information of the user, and activity pattern information of the user.

The search module 225 is a module that searches for information associated with the extension keyword and keyword extracted by the life log analyzing module 224 among information generated by the experience information unit indexing module 221 and the episode grouping module 222 and induces a search result according to the search.

As described above, the controller 230 controls an overall operation of a context-aware search apparatus using various software modules stored in the storage 220. The controller 230 may include a RAM 231, a ROM 232, and a CPU 233. The RAM 231, the ROM 232, and the CPU 233 may be connected to each other via a bus (not shown).

The CPU 233 may access the storage 220 and perform various operations using content, data, etc. stored in the storage 220. Further, the CPU 233 as well as controls a booting-related operation of the context-aware search apparatus 200 and execution of various software modules stored in the storage 220.

The ROM 232 stores a command for system booting. When a turn on command is input to power on the CPU 233, the CPU 233 copies an operating system (O/S) stored in the storage 220 to the RAM 231 according to a command stored in the ROM 232 and executes the O/S to boot a system. When booting is completed, the CPU 233 copies various software modules including the experience information unit indexing module 221, the episode grouping module 222, and the context-aware access module 223, stored in the storage 220, to the RAM 231 and executes the software module copied to the RAM 231 to perform the aforementioned operation.

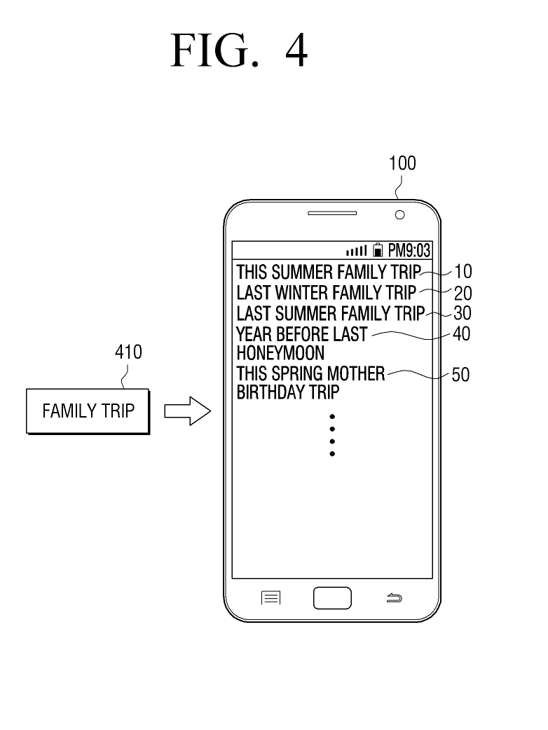

FIG. 4 is a diagram of an exemplary case in which a user equipment apparatus 100 provides a search result according to a search request of a user, according to an exemplary embodiment.

As illustrated in FIG. 4, the user equipment apparatus 100 may receive a search request 410 via a voice generated from the user or manipulation of a keypad (not shown) of the user equipment apparatus 100 by the user. When the search request 410 of the user is input to the user equipment apparatus 100, the user equipment apparatus 100 transmits the input search request 410 to the context-aware search apparatus 200. As illustrated in FIG. 4, the user equipment apparatus 100 may receive the search request “family trip”. Accordingly, the user equipment apparatus 100 transmits the input search request “family trip” to the context-aware search apparatus 200.

Upon receiving the search request “family trip”, the controller 230 of the context-aware search apparatus 200 analyzes the received search request to extract keywords “family” and “trip” and selects extension keywords from the pre-extracted keywords based on the pre-defined life log information of the user. Then, the controller 230 may search for information of the pre-selected extension keywords and the pre-extracted keywords from among the plurality of experience information units and episode information units pre-stored in the storage 220 and transmit a search result according to the search to the user equipment apparatus 100.

An operation of the controller 230 for inducing the search result and transmitting the search result to the user equipment apparatus 100 has been described in detail, and thus, a detailed description thereof will be omitted hereinafter.

The user equipment apparatus 100 may receive a retrieved search result in relation to the search request “family trip” from the context-aware search apparatus 200 and display the search result on a screen.

In detail, the user equipment apparatus 100 may display a plurality of items 10 to 50 based on the retrieved search result in relation to the search request “family trip”. As illustrated in FIG. 4, the plurality of items 10 to 50 displayed on the screen of the user equipment apparatus 100 are items to which priority is applied according to a preset condition among a plurality of items included in the retrieved search result in relation to the search request “family trip” by the context-aware search apparatus 200.

In certain exemplary embodiments, priority of the plurality of items 10 to 50 displayed on the screen of the user equipment apparatus 100 may be determined according to combinations of information about most-recently collected personal raw data in relation to the search request “family trip” and most-recently defined life log information among pre-defined life log information, and the plurality of items 10 to 50 may be displayed on the screen based on the determined priority.

Hereinafter, a method of providing a search result according to a search request of a user by a context-aware search apparatus will be described in detail according to an exemplary embodiment.

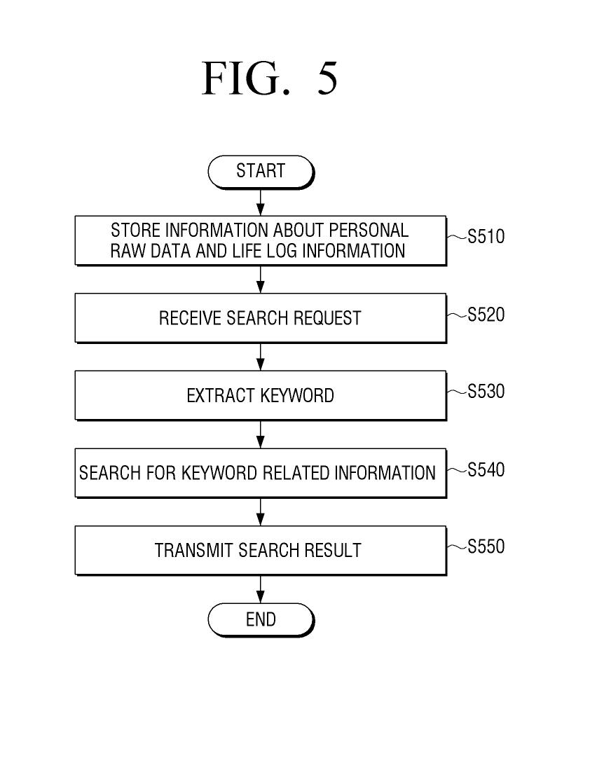

FIG. 5 is a flowchart of a context-aware search method for providing a search result according to a search request of a user by a context-aware search apparatus according to an exemplary embodiment.

As illustrated in FIG. 5, the context-aware search apparatus 200 stores life log information of the user and information about personal raw data collected from a routine activity of a user (S510). Here, the personal raw data includes at least one of a still image or moving picture captured by the user, note information input by the user in relation to a schedule or a memo, a phone log, history information using an SNS application, and SMS information. However, exemplary embodiments are not limited thereto. The personal raw data may include any information collected according to routine activities of the user via the user equipment apparatus 100 or content usage information according to content usage, provided from an external server (not shown).

The personal raw data may be pre-stored in the user equipment apparatus 100 or registered and stored in the context-aware search apparatus 200 according to an upload request of the user. However, exemplary embodiments are not limited thereto. The context-aware search apparatus 200 may periodically request and receive upload of the pre-stored personal raw data from the user equipment apparatus 100 and may register and store the received personal raw data.

The pre-defined life log information of the user may include at least one of personal information of the user, family information of the user, interest information of the user, a search history of the user, and activity pattern information of the user. The life log information may be information defined from factual information set based on user input and accumulating experience information units based on personal raw data collected according to a routine activity.

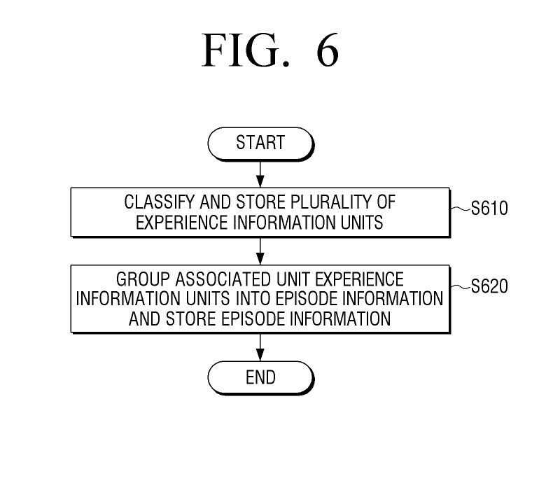

Information about the personal raw data collected according to the routine activity of the user may be generated and stored using a method illustrated in FIG. 6.

FIG. 6 is a flowchart of a method of generating and storing information about personal raw data by a context-aware search apparatus 200 according to an exemplary embodiment.

As illustrated in FIG. 6, when a plurality of personal raw data is collected, the context-aware search apparatus 200 classifies the plurality of personal raw data into a plurality of experience information units based on correlations between the collected personal raw data and stores and the experience information units (S610). Then, the context-aware search apparatus 200 groups the pre-stored plurality of experience information units in units of episodes and generates and stores a plurality of episode information units (S620).

Here, an experience information unit may include at least one of identification information for identifying the personal raw data, context information, URL information about a source providing the corresponding personal raw data, and counting information about a number of times the corresponding personal raw data is accessed.

In addition, the episode information unit may include at least one of identification information for identifying the corresponding episode information unit, information about a source providing personal raw data for respective experience information units included in the corresponding episode information unit, context information, and counting information about a number of times the episode information unit is accessed.

Referring to back to FIG. 5, upon receiving a search request of a user from the user equipment apparatus 100, the context-aware search apparatus 200 analyzes the received search request to extract a keyword (S520 and S530). Then, the context-aware search apparatus 200 searches for information associated with the pre-extracted keyword based on the pre-defined life log information of the user and transmits a search result according to the search to the user equipment apparatus 100 (S540 and S550).

Hereinafter, a search method in relation to a keyword extracted from the search request of the user by the context-aware search apparatus 200 will be described.

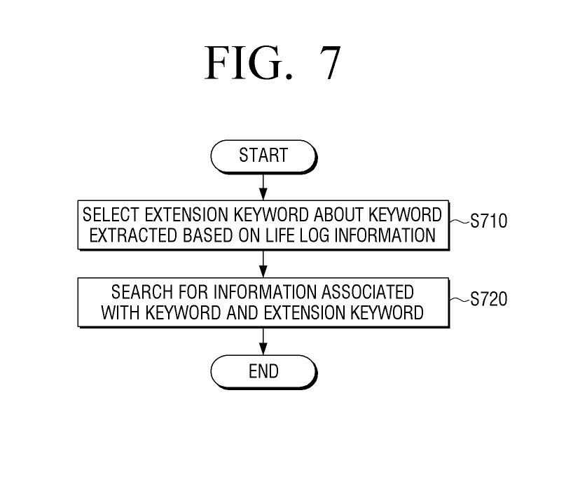

FIG. 7 is a flowchart of a search method according to a search request of a user by a context-aware search apparatus 200 according to an exemplary embodiment.

As illustrated in FIG. 7, when the search request of the user is analyzed to extract a keyword, the context-aware search apparatus 200 selects at least one extension keyword based on the pre-defined life log information of the user (S710). Then, the context-aware search apparatus 200 searches for information associated with the pre-selected extension keyword and the pre-extracted keyword among the pre-stored experience information units and episode information units (S720).

As in the aforementioned example, upon receiving a search request “last summer family trip”, the context-aware search apparatus 200 extracts keywords “last year”, “summer”, “family”, and “trip”. When the keywords are extracted, the context-aware search apparatus 200 may select extension keywords of at least one keyword among the pre-extracted keywords based on the pre-defined life log information of the user. For example, the context-aware search apparatus 200 may select extension keywords “users”, “spouses”, “sons and daughters”, “parents”, “brothers and sisters”, and “grand-parents” from the keyword “family”.

When the extension keyword of the keyword is selected, the context-aware search apparatus 200 may search for information associated with at least one of the pre-extracted and pre-selected extension keyword with reference to context information included in a plurality of episode information units and a plurality of experience information units that are pre-stored and transmit a search result according to the search to the user equipment apparatus 100.

The context-aware search apparatus 200 may transmit a retrieved search result according to a search result of a user in relation to a plurality of items included in the search result to the user equipment apparatus 100 using the following method.

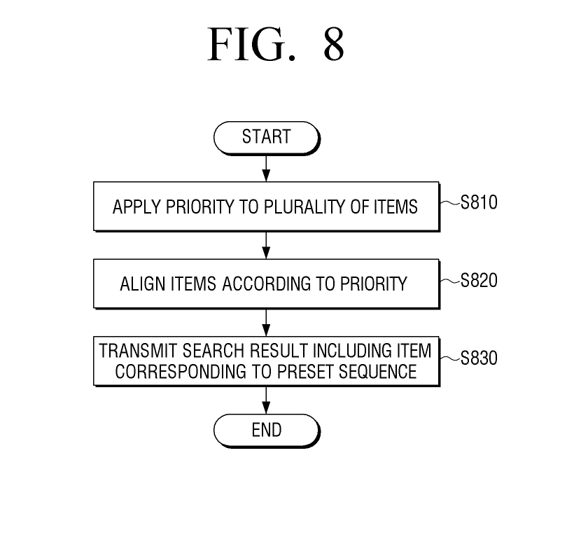

FIG. 8 is a flowchart of a method of transmitting a retrieved search result associated with a search request of a user by a context-aware search apparatus 200 to a user equipment apparatus 100 according to an exemplary embodiment.

As illustrated in FIG. 8, when the search result associated with the search request of the user is induced, the context-aware search apparatus 200 applies priority to a plurality of items included in the search result based on a search history of the user (S810). Then, the context-aware search apparatus 200 aligns the plurality of items according to priority and transmits a search result including an item corresponding to preset sequence among the plurality of aligned items according to priority to the user equipment apparatus 100 (S820 and S830).

As in the aforementioned example, keywords may be extracted from the search request “last summer family trip”, extension keywords may be selected in relation to the extracted keywords, and a search result of items may be induced in relation to the keywords and the extension keywords. In this case, the context-aware search apparatus 200 applies priority to each item in an order from an item that is most searched for by the user based on counting information included in episode information units or experience information units associated with the retrieved items. Then, the context-aware search apparatus 200 may align the items according to priority and transmit the items to the user equipment apparatus 100.

The context-aware search apparatus 200 may induce a search result of items, the number of which exceeds a preset number of items in relation to the keyword and the extension keyword. In this case, the context-aware search apparatus 200 may select only a certain number of items among the retrieved items and transmit the certain number of items to the user equipment apparatus 100.

According to an exemplary embodiment, when a search result of items is induced, the context-aware search apparatus 200 applies priority to the items in an order from an item that is most searched for by the user based on counting information included in episode information units or experience information units associated with each of the items. Then, the context-aware search apparatus 200 may align the items according to priority, select only items within preset sequences from among the aligned items, and then, transmit the selected items to the user equipment apparatus 100.

According to another exemplary embodiment, when a search result of items is induced, the context-aware search apparatus 200 may align the items in an order from an item having highest correlation with a keyword and an extension keyword with reference to context information included in episode information units or experience information units associated with each of the items, select only a preset number of items from the items having a high correlation, and transmit the preset number of items to the user equipment apparatus 100.

According to another exemplary embodiment, when a search result of items is induced, the context-aware search apparatus 200 may select only a specific item from the items based on context information included in episode information units or experience information units associated with each of the items and most-recently set life log information and transmit the specific item to the user equipment apparatus 100. As in the aforementioned example, extension keywords “users”, “spouses”, “sons and daughters”, “parents”, “brothers and sisters”, and “grand-parents” may be selected from the keyword “family” and the extension keywords “spouses” and “sons and daughters” among the extension keywords may be the most recently set life log information in relation to the keyword “family”.

Thus, when a search result of items is induced, the context-aware search apparatus 200 may select only an item associated with at least one extension keyword of “spouses” and “sons and daughters” with reference to context information included in episode information units and experience information units associated with each item and transmit the selected item to the user equipment apparatus 100.

Thus far, the exemplary embodiments have been described.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the inventive concept, as defined by the appended claims, and many alternatives, modifications, and variations will be apparent to those skilled in the art.

What is claimed is:

1. A context-aware search apparatus comprising:
a storage configured to store information about personal raw data collected from a routine activity of a user and life log information of the user;
a communicator configured to communicate with a user equipment apparatus; and
a controller configured to, in response to receiving a search request of the user through the communicator, extract a keyword from the search request, search the storage for information associated with the keyword based on the life log information of the user, and transmit a result of the search to the user equipment apparatus.

2. The context-aware search apparatus as claimed in claim 1, wherein the controller is further configured to, in response to the personal raw data being collected, classify the personal raw data into a plurality of experience information units based on correlations in the personal raw data, store the plurality of experience information units in the storage, group the plurality of experience information units in units of episodes, and store, in the storage, the plurality of experience information units as a plurality of episode information units.

3. The context-aware search apparatus as claimed in claim 2, wherein the controller is further configured to, in response to the keyword being extracted from the search request, select at least one extension keyword based on the life log information of the user and search for information associated with the keyword and the extension keyword from among the plurality of experience information units and the plurality of episode information units.

4. The context-aware search apparatus as claimed in claim 3, wherein the controller is further configure to apply priority to a plurality of items included in the result of the search based on a search history of the user, align the plurality of items according to the applied priority, and provide the aligned plurality of items to the user equipment apparatus.

5. The context-aware search apparatus as claimed in claim 1, wherein the personal raw data comprises at least one from among a still image, a moving picture, a phone log, social network service (SNS) history information, and short message service (SMS) information.

6. The context-aware search apparatus as claimed in claim 1, wherein the life log information of the user comprises at least one from among personal information of the user, family information of the user, interest information of the user, search history information of the user, and activity pattern information of the user.

7. The context-aware search apparatus as claimed in claim 2, wherein each of the plurality of experience information units comprises at least one from among identification information for identifying the personal raw data, context information, uniform resource locator (URL) information about a source providing the personal raw data, and counting information about a number of times the personal raw data is accessed.

8. A context-aware search method comprising:
storing information about personal raw data collected from a routine activity of a user and life log information of the user;
receiving a search request of the user from a user equipment apparatus;
extracting a keyword from the search request and searching for information associated with the keyword based on the life log information of the user; and
transmitting a result of the searching to the user equipment apparatus.

9. The context-aware search method as claimed in claim 8, wherein the storing comprises:
classifying the personal raw data into a plurality of experience information units based on correlations in the personal raw data and storing the plurality of experience information units; and
grouping the plurality of experience information units in units of episodes and storing the plurality of experience information units as a plurality of episode information units.

10. The context-aware search method as claimed in claim 9, wherein the searching comprises:
selecting at least one extension keyword based on the life log information of the user in response to the keyword being extracted from the search request; and
searching for information associated with the keyword and the extension keyword among the plurality of experience information units and the plurality of episode information units.

11. The context-aware search method as claimed in claim 10, wherein the transmitting comprises:
applying priority to a plurality of items included in the result of the searching based on a search history of the user;
aligning the plurality of items according to the priority; and
transmitting a result of the searching comprising an item corresponding to a preset sequence among the plurality of aligned items, to the user equipment apparatus.

12. The context-aware search method as claimed in claim 8, wherein the personal raw data comprises at least one from among a still image, a moving picture, a phone log, social network service (SNS) history information, and short message service (SMS) information.

13. The context-aware search method as claimed in claim 8, wherein the life log information of the user comprises at least one from among personal information of the user, family information of the user, interest information of the user, search history information of the user, and activity pattern information of the user.

14. The context-aware search method as claimed in claim 9, wherein each of the plurality of experience information units comprises at least one from among identification information for identifying the personal raw data, context information, uniform resource locator (URL) information about a source providing the personal raw data, and counting information about a number of times the personal raw data is accessed.

15. A context-aware search method comprising:
collecting personal raw data corresponding to an activity of a user;
transmitting the personal raw data to a context-aware search apparatus;
transmitting a search request to the content-aware search apparatus; and
receiving, in response to the transmitting the search request, a result of a search,
wherein the result of the search is generated by searching for information corresponding to the personal raw data based on a keyword extracted from the search request and an extension keyword based on life log information of the user.

16. The context-aware search method as claimed in claim 15, wherein the personal raw data is classified into a plurality of experience information units based on correlations in the personal raw data,
wherein the plurality of experience information units are grouped into a plurality of episode information units, and
wherein the searching for information includes searching for information associated with the keyword and the extension keyword from among the plurality of experience information units and the plurality of episode information units.

17. The context-aware search method as claimed in claim 15, wherein the personal raw data comprises at least one from among a still image, a moving picture, a phone log, social network service (SNS) history information, and short message service (SMS) information.

18. The context-aware search method as claimed in claim 15, wherein the life log information of the user comprises at least one from among personal information of the user, family information of the user, interest information of the user, search history information of the user, and activity pattern information of the user.

19. The context-aware search method as claimed in claim 15, wherein the method further comprises displaying the result of the search.

20. The context-aware search method as claimed in claim 15, wherein the result of the search includes a plurality of items, and
the method further comprises sequentially displaying the plurality of items based on a priority of each of the plurality of items.
